(19) United States
(12) Patent Application Publication
(10) Pub. No.: US 2026/0091756 A1
(43) Pub. Date: Apr. 2, 2026

(54) SEAT, IN PARTICULAR VEHICLE SEAT

(71) Applicants: Adient US LLC, Plymouth, MI (US); Autoliv Development AB, Vårgårda (SE)

(72) Inventors: Ludger MÜHLENBROCK, Recklinghausen (DE); Jens EHLERS, Horst (DE)

(21) Appl. No.: 19/345,397

(22) Filed: Sep. 30, 2025

(30) Foreign Application Priority Data
Oct. 1, 2024 (EP) 24 203 829.7

(51) Int. Cl. B60R 22/195; B60R 22/26

(52) U.S. Cl. CPC B60R 22/1954; B60R 22/26

(57) ABSTRACT

A seat, configured as a vehicle seat, may have been a seat part, a backrest which is connected to the seat part, and a safety belt which may be a belt strap for restraining an occupant seated on the seat or a dummy arranged on the seat. The belt strap may extend between two lower belt anchorage points and an upper belt anchorage point. During an increased action of force, in particular a test-induced action of force, on the seat, the two lower belt anchorage points may be configured so as to be movable in an advancing manner.

### FIELD

The invention relates to a seat, in particular a vehicle seat.

### BACKGROUND

Tests of vehicle seats are well known from the prior art. For example, test dummies (also called crash test dummies) are used to test the vehicle seat. Here, the effects of an accident on the human body are simulated by means of the test dummy. Furthermore, by means of pulling devices according to UN Regulation No. 14 (Uniform provisions concerning the approval of vehicles with regard to safety-belt anchorages, EU Gazette of 12.13.2019, L 324/14-L324/46, [2019/2141]; called UN Regulation No. 14 for short in the further text; English version: UNECE: UN-R 14/09, Suppl. 3, 02.07.2024), static tests are carried out which simulate the effects on the belt anchorage points.

Furthermore, the prior art, for example US 2001/0011810 A1, EP 1 362 737 A1, WO 02/066285 A1, U.S. Pat. No. 11,091,120 B2 and US 2023/365098 A1, has disclosed seats such as, for example, vehicle seats or bus seats, which are adjustable between different positions, in particular different seat positions, reclined positions, bed positions or the like.

Here, a seat of this type has to have sufficient strength and has to also be able to absorb belt forces and ensure that accident-induced excessive advancing movement of the pelvis or submarining (the pelvis “diving” under the belt) does not occur.

### SUMMARY

The invention is based on the problem of providing a seat of the type mentioned at the outset which ensures, in particular, that accident-induced advancing movements of the pelvis and submarining can be reduced or even avoided.

According to the invention, this problem is solved by a seat with the features of claim 1.

Advantageous refinements which can be used individually or in combination with one another are the subject matter of the subclaims.

The seat according to the invention is configured as a vehicle seat, for example for one of the vehicle classes M1/M1G/M2/M3 or N1/N2/N3, as are defined by way of example in UN Regulation No. 14, Annex 6 or Point 5.4.2.1, and comprises at least a seat part, a backrest which is connected to the seat part, and a safety belt which comprises a belt strap for restraining an occupant seated on the seat or a dummy arranged on the seat, wherein the belt strap extends between two lower belt anchorage points and an upper belt anchorage point, and wherein, during an increased action of force on the seat, the two lower belt anchorage points are configured such that they are movable in an advancing manner forward and/or rearward.

In particular, the two lower belt anchorage points are configured such that they are movable in an advancing manner, during the increased action of force, in particular a control-induced action of force, from a starting position of a predetermined lower effective belt anchorage (also called lower effective belt anchorage position) forward and/or rearward into a predetermined control region, in particular into a control position. In other words: as a reaction to an action of force, in particular a test force, the lower belt anchorage points can be moved beyond their effective positions (=lower effective belt anchorage position).

As a result, the load acting on the body of the occupant can be reduced by controlled shifting of the belt system. In addition, the safety belt can be tested with regard to a test load. This controlled movement absorbs impact energy and redistributes it, as a result of which peaked forces which are transmitted to the occupant are reduced and the occupant safety is improved in the case of crash events.

The increased action of force is understood to mean, in particular, a control-induced action of force (also called test-induced action of force) with a test load which acts on the seat, in particular on the safety belt, for example of tensile forces, wherein the seat is loaded with force, in particular a test load by means of pulling apparatuses, which is higher than the normal use of the seat. The increased action of force is carried out in accordance with UN Regulation No. 14, Point 6. TESTS to Point 7. INSPECTIONS DURING AND AFTER STATIC TESTS FOR SAFETY-BELT ANCHORAGES, page L324/23 to L324/28, Point 7.4, the contents of which are incorporated herein by citation.

The lower belt anchorage points are understood to mean, in particular, the lower effective belt anchorages L1, L2 in accordance with UN Regulation No. 14, Number 5.4., Location of belt anchorages, pages L324/20 to L324/21, Point 5.4.2.5 und Annex 3, FIGS. 1 to 2. The lower belt anchorage points can be attached, for example, to a vehicle structure, a seat structure or to another part of the vehicle, or can be distributed to these different attachment points.

Here, each lower belt anchorage point can be provided and configured for fastening the ends of two safety belts, which lie next to one another, of two seats, which are arranged next to one another.

The increased action of force is understood to mean, in particular, a test load such as, for example, a tensile force, which acts on the safety belt.

An advancing movement of the lower belt anchorage points is understood to mean, in particular, a combined movement of a pivoting movement forward and a linear movement forward and/or rearward or only a pivoting movement or only a linear movement forward and/or rearward.

Here, the invention proceeds from the consideration that these lower effective belt anchorages L1, L2 in accordance with UN Regulation 14, Point 5.1.3, lie for the respective seat variants in defined angular ranges α1, α2 in accordance with UN Regulation 14, Point 5.1.5, from which they must not depart in all customary use positions. During a test, in particular an inspection test by simulation of an accident (crash), no restriction of the position of the lower belt anchorage points is predefined in accordance with UN Regulation 14.

The advantages achieved by way of the invention consists in that there is a realistic load, acting on the seat and the safety belt, of a person by means of a dummy (also called test dummy or crash test dummy), wherein the advancing movement, in particular a movement forward and/or rearward, of the lower belt anchorage points can ensure that a test-induced pelvis advancing movement and/or submarining of the dummy/crash test dummy does not occur. It can therefore be ensured that the safety belt can be tested completely for the test load which acts.

During the normal action of force, for example in use positions of the seat, the lower belt anchorage points are arranged and held in a stationary manner. An advancing movement of the lower belt anchorage points is provided exclusively in the case of a test-induced increased action of force.

In addition, the lower belt anchorage points can be movable downward during the increased action of force. As a result, the safety belt is tensioned to a greater extent. Therefore, the safety belt can bear more tightly against the dummy and can secure the latter, with the result that it does not “slip through” below the safety belt.

For example, the lower belt anchorage points can be mechanically movable in an advancing manner during the increased action of force. In particular, the lower belt anchorage points can be movable in an advancing manner by means of a pyrotechnic unit during the increased action of force.

The pyrotechnic unit can comprise, for example, a triggering unit and an airbag which, by activation by means of the triggering unit, activates a mechanism which moves the two belt anchorage points forward and/or downward.

As an alternative, the lower belt anchorage points can be movable in an advancing manner via at least one preloading element during the increased action of force. For example, in the case of an increased action of force, in particular as a result of a tensile force, on the belt strap, the preloading element is activatable by means of this belt strap, wherein the preloading element can pass here into engagement with the belt anchorage points for the advancing movement of the latter. As an alternative, the preloading element can be coupled directly to the lower belt anchorage points, in order to move them in an advancing manner directly upon activation by the belt strap. For example, a separate preloading element can be provided per lower belt anchorage point.

For example, the respective lower belt anchorage point can be movable in an advancing manner forward and/or downward, in particular can be pivotable, during the increased action of force from a legally specified region of, for example, in each case by more than 0.5° and/or more than 2 mm with respect to a predetermined starting position of the seat before loading with a test load. The starting position of the respective lower belt anchorage point corresponds here to the defined position of the lower effective belt anchorage in accordance with UN Regulation No. 14, Point 5.4.2 ff., In particular the angle α1, α2 listed on page L324/43, in the table of the Annex and additionally defined in Point 5.1.5. The contents of UN Regulation No. 14 according to the table on page L324/43, Points 5.1.5. and 5.4.2.1. to 5.4.2.4. is included herein by way of citation. Here, these angles α1, α2 differ depending on the vehicle type and/or seat type and can therefore vary, as described by way of example in UN Regulation No. 14, in Points 5.4.2.1 to 5.4.2.4.

In particular, the lower belt anchorage points are configured such that they are movable in an advancing manner exclusively during the inspection-induced or test-induced action of force, in particular an increased action of force taking place under a predetermined test load, as described by way of example in UN Regulation No. 14, Point 6.4 “Particular test requirements for seat belt anchorages”.

For example, the two lower belt anchorage points can be configured such that they are movable in an advancing manner at the same time or synchronously. As an alternative, they can be movable in an advancing manner differently in an event-controlled way.

In summary and in other words, the invention provides a seat, the lower effective belt anchorages of which are moved by a mechanism during the crash (an accident) or a test-induced increased action of force, in such a way that they:
1) are displaced forward in the direction of travel and/or rearward from a predetermined region, in particular from a predetermined legal region;
2) are displaced forward in the direction of and/or rearward travel from the predetermined region, in particular from a predetermined legal region, and at the same time a move downward; or
3) are pivoted forward in the direction of travel and/or downward from a predetermined region, in particular from a predetermined legal region;
in order to additionally achieve tensioning of the belt and/or improved belt routing.

The movement can be carried out, for example, by means of different mechanisms as follows:
a) by means of a pyrotechnic unit which moves the mechanism directly or by means of a deflection means,
b) by means of a pyrotechnic unit which, for example, in flights an airbag which then in turn moves the mechanism,
c) by means of a preloaded element which is released, for example, by the belt force in the crash (accident), and/or
d) by means of a direct mechanism such as, for example, a tensioning mechanism, a spring mechanism or the like which, for example, is released by the belt force in the crash (accident).

### DESCRIPTION OF THE FIGURES

In the following text, the invention is explained in greater detail on the basis of advantageous exemplary embodiments shown in the figures. The invention is not restricted to these exemplary embodiments, however. In the figures:

FIG. 1 shows a diagrammatic illustration of a seat, in particular a vehicle seat with a longitudinal adjustment device,

FIG. 2 shows a diagrammatic illustration of a seat according to the invention with two lower belt anchorage points which are movable in an advancing manner and an upper belt anchorage point, and

FIG. 3 shows a diagrammatic illustration of the seat according to FIG. 2 with the two lower belt anchorage points which are movable in an advancing manner.

### DETAILED DESCRIPTION

Parts which correspond to one another are provided with the same designations in all the figures.

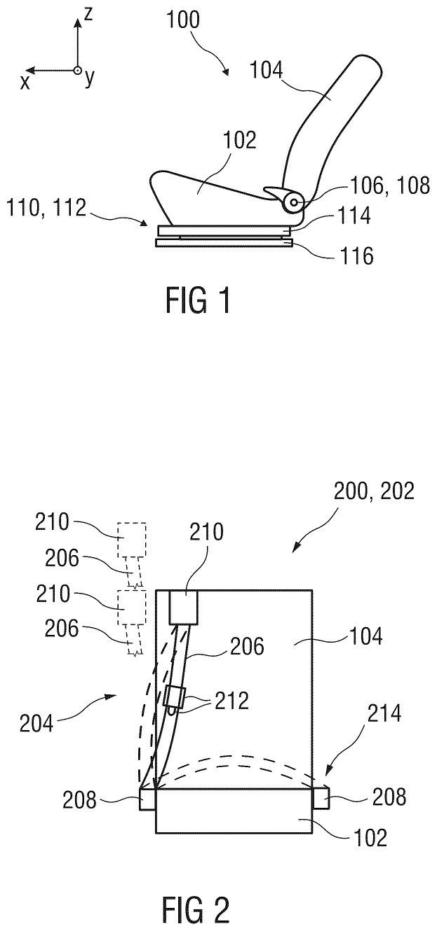

A vehicle seat 100 (shown diagrammatically in FIG. 1 with respect to the prior art) is described in the following text with use of three spatial directions which run perpendicularly with respect to one another. In the case of a vehicle seat 100 which is installed in the vehicle, a longitudinal direction x runs largely horizontally and preferably parallel to the vehicle longitudinal direction which corresponds to the usual direction of travel of the vehicle. A transverse direction y which runs perpendicularly with respect to the longitudinal direction x is likewise oriented horizontally in the vehicle and runs parallel to the vehicle transverse direction. A vertical direction z runs perpendicularly with respect to the longitudinal direction x and perpendicularly with respect to the transverse direction y. In the case of a vehicle seat 100 which is installed in the vehicle, the vertical direction z preferably runs parallel to a vehicle vertical axis.

The positional specifications and directional specifications which are used such as, for example, front, rear, top and bottom relate to a viewing direction of an occupant seated in the vehicle seat 100 in a normal seat position, wherein the vehicle seat 100 is installed in the vehicle, has an upright backrest 104 in a use position which is suitable for passenger transport, and is oriented in the direction of travel as is usual. A vehicle seat 100 is understood to mean, in particular, a seat 200 such as, for example, an individual seat or part of a seat bench, as is defined in UN Regulation No. 14, Point 2.6, the definition of which is included hereby by way of reference. The vehicle seat 100 can also, however, be installed all moved in a different orientation, for example as a rearwardly directed seat 200. Unless described otherwise, the vehicle seat 100 can be constructed, for example, mirror-symmetrically with respect to a plane which runs perpendicularly with respect to the transverse direction y. A seat bench or a narrow vehicle seat 100 or another suitable vehicle seat 100 can also be provided as vehicle seat 100.

The backrest 104 can be arranged pivotably on a seat part 102 of the vehicle seat 100. To this end, the vehicle seat 100 can optionally comprise a fitting 106, in particular an adjusting fitting, rotary fitting, latching fitting or tumbling fitting.

The positional specifications and directional specifications which are use such as, for example, radial, axial and in the circumferential direction, relate to a rotational axis 108 of the fitting 106. Radial means perpendicularly with respect to the rotational axis 108. Axial means in the direction of or parallel to the rotational axis 108.

The vehicle seat 100 can optionally comprise a longitudinal adjustment device 110. The longitudinal adjustment device 110 comprises, for example, a rail arrangement 112 with a first rail element 114 and a second rail element 116. The first rail element 114 is adjustable relative to the second rail element 116 in the longitudinal direction x. The first rail element 114 is fastened to the seat part 102. The second rail element 116 is fastened to a structural element of a vehicle, for example a vehicle floor.

For improved clarity, the first rail element 114 is called the upper rail 114 in the following description. This upper rail 114 (also called running rail or slide) is assigned to the vehicle seat 100 and is configured to support this vehicle seat 100. The second rail element 116 is called the lower rail 116 in the further text. The lower rail 116 is connected fixedly and, for example, to the floor of a vehicle.

The vehicle seat 100 can be configured, for example, as a conventional seat 200 with a safety belt 204 (as shown in FIG. 2) or as a seat with an integrated belt 202.

FIG. 2 shows a seat 200, in particular configured as a vehicle seat 100. The seat 200 can be a seat with an integrated belt 202 for a vehicle. As an alternative, the seat 200 can be equipped conventionally with a safety belt 204 which is fastened to a vehicle structure or to other vehicle components, as indicated by the dashed options.

The seat 200 can be, for example, a vehicle seat 100 according to one of the vehicle classes M1/M1G/M2/M3 or N1/N2/N3, as are defined by way of example in UN Regulation No. 14, Annex 6 or Point 5.4.2.1. The seat 200 can be, in particular, a bus seat, a van seat, a truck seat or the like.

In an analogous manner with respect to the vehicle seat 100, the seat 200 comprises at least the seat part 102 and the backrest 104 which is connected to the seat part 102.

The seat 200 as a seat with an integrated belt 202 comprises a safety belt 204 which is integrated on the seat 200. The safety belt 204 comprises at least one belt strap 206 for restraining an occupant (not shown in greater detail) seated on the seat 200 or a dummy (not shown in greater detail) arranged on the seat 200.

The belt strap 206 extends between two lower belt anchorage points 208 and an upper belt anchorage 210. The belt strap 206 can extend within the seat 200 (shown using dashed lines) and partially on the seat 200 (shown using a solid line), and can be deflected at two belt anchorage points 208, 210 and can be held in a secured manner at the remaining lower belt anchorage 208 by means of a belt tongue 212 which engages releasably into a belt buckle 214.

The upper belt anchorage point 210 is integrated, for example, into the seat 200. As an alternative, this upper belt anchorage. 210 can also be fastened to a side wall, in particular B-pillar or C-pillar or another suitable location, for example in the roof or in the rear bulkhead or the like, of the vehicle structure. The lower belt anchorage points 208 are arranged on the side of the seat 200 on a seat structure of the seat part 102. As an alternative, the lower belt anchorage points 208 can be attached to a vehicle structure or to another part of the vehicle.

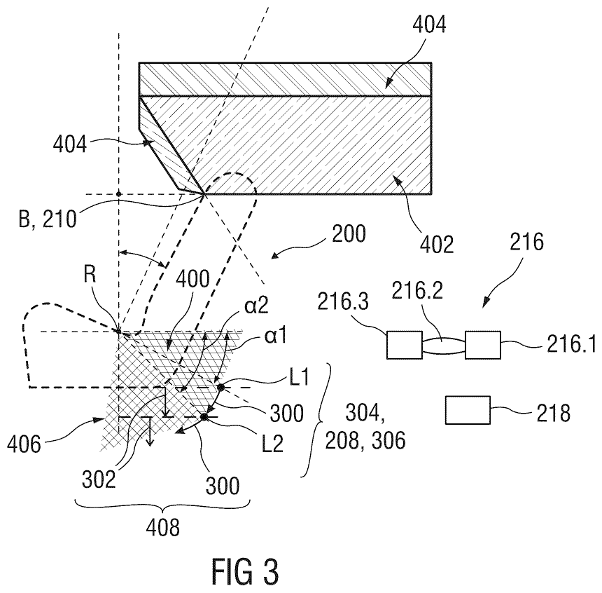

FIG. 3 shows the seat 200 from the side and a first permissible attachment region 400 according to UN Regulation No. 14 for the position of lower effective anchorages L1, L2 for the respective lower belt anchorage point 208 on the relevant seat side, and a second permissible attachment region 402 for the position of upper effective anchorages B for the upper belt anchorage 210.

In particular, the two lower belt anchorage points 208 are movable in an advancing manner during an increased action of force, in particular a test-induced action of force, from a starting position 304 of a predetermined lower effective belt anchorage 36 (also called the lower effective belt anchorage position) forward and/or rearward into a predetermined control region 406, in particular into an arbitrary control position 408 in the control region 406. In other words: the lower belt anchorage points 208 can be moved beyond their effective positions (=lower effective belt anchorage position=lower effective belt anchorage 306) as a reaction to an action of force, in particular a test force.

As a result, the load which acts on the body of the occupant can be reduced by a controlled movement of the safety belt 204 (also called the belt system). In addition, the safety belt 204 can be tested with regard to a test load. This controlled movement absorbs impact energy and redistributes it, as a result of which peak forces which are transmitted to the occupant are reduced and the occupant safety in crash events is improved.

Here, further permissible attachment regions 404 can be predetermined for additional upper belt anchorage points 210. The definition of these permissible attachment regions 400, 402, 404 for the attachment regions of the effective belt anchorages L1, L2, B is stated in the UN Regulation No. 14 in Annex 3, pages L324/35 to L324/36, the contents of which are included hereby by way of citation.

According to UN Regulation No. 14, Point 5.1.3 and Annex 3, FIG. 1, these lower effective belt anchorages L1, L2 for the respective seat variants lie within defined angular ranges α1, α2 in a manner dependent on the respective vehicle type and/or seat type (UN Regulation No. 14, Annex 3, FIG. 1 and table in the appendix on page L324/43), for example in a region from 20° to 80° of the predetermined first attachment region 400 for customary use positions of the seat 200.

The upper effective belt anchorage B can lie in the predetermined permissible attachment regions 404 and 402 for customary use positions of the seat 200, as shown in UN Regulation No. 14, Annex 3, FIG. 1.

The seat 200 has a reference point R for determining these permissible attachment regions 400, 402, 404.

The invention provides that the relevant lateral lower belt anchorage point 208 is movable in an advancing manner during the increased action of force on the seat 200 during an inspection test according to the arrows 300, 302, in particular into a predetermined control region 406, forward and/or rearward.

For example, the two lower belt anchorage points 208 are movable in an advancing manner under the increased action of force, in particular a test-induced action of force (also called a an inspection-induced action of force), with a test load which acts on the seat 200, in particular on the safety belt 204, for example tensile forces, forward and/or rearward.

The increased action of force is indicated according to UN Regulation No. 14, point 6. TESTS to point 7. INSPECTION DURING AND AFTER STATIC TESTS FOR SAFETY BELT ANCHORAGES, pages L324/23 to L324/28, Point 7.4, the contents of which are included hereby by way of citation.

A movement in an advancing manner of the lower belt anchorage points 208 (as shown in FIG. 2) is understood to mean, in particular, a combined movement of the pivoting movement according to arrow 300 forward and a linear movement according to arrow 302 downward or only a pivoting movement or only a linear movement forward and/or downward.

Here, the invention proceeds from the consideration that these lower effective belt anchorages L1, L2 according to UN Regulation 14, Point 5.1.3 for the respective seat variants lie in defined angular ranges α1, α2 according to UN Regulation No. 14, Point 5.1.5 and table in the annex on page L324/43, which they must not depart from in all customary use positions.

During the test, in particular the inspection test by simulation of an accident (crash), no restriction of the position of the lower effective belt anchorages L1, L2 is predetermined according to UN Regulation No. 14.

The advantages achieved by way of the invention consist in that there is a realistic load, acting on the seat 200 and the safety belt 204, of a person by means of a dummy (also called test dummy or inspection dummy (not shown)), wherein the movement in an advancing manner of the lower belt anchorage points 208 into the predetermined control region 406 can ensure that a test-induced movement of the pelvis in an advancing manner and/or what is known as submarining of the dummy occurs/occurs. This can ensure that the safety belt 204 can be tested completely for the test load which acts.

During a normal action of force, for example in use positions of the seat 200, the lower belt anchorage points 208 are arranged and held in a stationary manner. A movement in advancing manner of the lower belt anchorage points 208 is provided exclusively in the case of a test-induced increased action of force or release by one of the above-described mechanisms such as, for example, a pyrotechnic unit 216, a preloading element, a tensioning mechanism, a spring mechanism or the like.

In addition, the lower belt anchorage points 208 can be movable downward according to arrow 302 during the increased action of force. As a result, the safety belt 204 is tautened to a more pronounced extent. Therefore, the safety belt 204 can bear more tightly against the dummy and secure the latter, with the result that this dummy cannot “slip through” below the safety belt 204.

For example, the lower belt anchorage points 208 can be movable in an advancing manner mechanically downward and/or forward during the increased action of force. In particular, the lower belt anchorage points 208 can be movable in an advancing manner by means of a pyrotechnic unit 216 during the increased action of force.

The pyrotechnic unit 216 can comprise, for example, a triggering unit 216.1 and an air bag 216.2 which, by activation by means of the triggering unit 216.1, activates a mechanism 216.3 which moves the two lower belt anchorage points 208 forward and/or downward according to the arrows 300, 302.

As an alternative, the lower belt anchorage points 208 can be movable in an advancing manner forward and/or downward by at least one preloading element 218 during the increased action of force. For example, in the case of an increased action of force, in particular as a result of a tensile force, on the belt strap 206, the preloading element 218 is activatable by means of this belt strap 206.

The preloading element 218 can pass, for example, into engagement with the lower belt anchorage points 208 for the movement in advancing manner thereof. As an alternative, the preloading element 218 can be coupled directly to the lower belt anchorage points 208, in order to move the latter in an advancing manner directly upon activation by the belt strap 206. For example, a separate preloading element 218 can be provided per lower belt anchorage point 208.

For example, the respective lower belt anchorage point 208 can be movable in an advancing manner, in particular pivotable, forward and/or downward into the predetermined control region 406 in each case by more than 1°, in comparison with a predetermined starting position, in particular the starting position of the lower effective belt anchorages L1, L2 without the action of a test load.

In other words: the starting position of the respective lower belt anchorage point 208 corresponds here to the defined position of the lower effective belt anchorages L1, L2 according to UN Regulation No. 14, Point 5.4.2 et seq.

In addition or as an alternative, the lower belt anchorage points 208 can be configured so as to be movable forward and/or downward into the predetermined control region 406 during the increased action of force from the legally specified region, for example in each case by more than 2 mm, 0.5 mm with respect to the predetermined starting position.

In particular, the lower belt anchorage points 208 are configured so as to be movable in advancing manner forward and/or downward exclusively during the test-induced or inspection-induced action of force, in particular an increased action of force which takes place under a predetermined test load.

For example, the two lower belt anchorage points 208 can be configured so as to be movable in an advancing manner forward and/or downward at the same time or synchronously by means of the at least one pyrotechnic unit 216 and/or by means of the at least one preloading element 218. As an alternative, they can be movable in advancing manner forward and/or downward to a different extent in an event-driven manner.

Here, each lower belt anchorage point 208 can be provided and configured for fastening the ends of the two safety belts 204, lying next to one another, of two seats 200 which are arranged next to one another.

### LIST OF DESIGNATIONS

100 Vehicle seat
102 Seat part
104 Backrest
106 Fitting
108 Rotational axis
110 Longitudinal adjustment device
112 Rail arrangement
114 First rail element (upper rail)
116 Second rail element (lower rail)
200 Seat
202 Seat with integrated belt
204 Safety belt
206 Belt strap
208 Lower belt anchorage point
210 Upper belt anchorage point
212 Belt tongue
214 Belt buckle
216 Pyrotechnic unit
216.1 Triggering unit
216.2 Airbag
216.3 Mechanism
218 Preloading element
300 Arrow
302 Arrow
304 Starting position
306 Predetermined lower effective belt anchorage
400 First permissible attachment region
402 Second permissible attachment region
404 Further permissible attachment regions
406 Predetermined control region
408 Control position
B Upper effective belt anchorage
L1, L2 Lower effective belt anchorages
R Reference point of the seat
x Longitudinal direction
y Transverse direction
Z Vertical direction
α1, α2 Angular ranges

1. A seat, configured as a vehicle seat, comprising:
a seat part,
a backrest which is connected to the seat part, and
a safety belt which comprises a belt strap for restraining an occupant seated on the seat or a dummy arranged on the seat,
wherein the belt strap extends between two lower belt anchorage points and an upper belt anchorage point,
wherein, during an increased action of force on the seat, the two lower belt anchorage points are configured so as to be movable in an advancing manner from a starting position of a predetermined lower effective belt anchorage forward and/or downward into a predetermined control region.

2. The seat as claimed in claim 1, wherein the increased action of force is a control-induced action of force.

3. The seat as claimed in claim 1, wherein the lower belt anchorage points are arranged and held in a stationary manner during a normal action of force.

4. The seat as claimed in claim 1, wherein the lower belt anchorage points are mechanically movable in an advancing manner forward and/or downward during the increased action of force.

5. The seat as claimed in claim 1, wherein the lower belt anchorage points are movable in an advancing manner by means of a pyrotechnic unit during the increased action of force.

6. The seat as claimed in claim 5, wherein the pyrotechnic unit comprises a triggering unit and an airbag which, as a result of activation by means of the triggering unit, activates a mechanism which moves the two lower belt anchorage points forward and/or downward.

7. The seat as claimed in claim 1, wherein the lower belt anchorage points are movable in an advancing manner by at least one preloading element during the increased action of force.

8. The seat as claimed in claim 7, wherein, in the case of an increased action of force on the belt strap, the preloading element is activatable by means of this belt strap and passes into engagement with the lower belt anchorage points for moving the latter in an advancing manner.

9. The seat as claimed in claim 7, wherein a preloading element is provided per lower belt anchorage point.

10. The seat as claimed in claim 7, wherein the respective lower belt anchorage point is movable in an advancing manner forward and/or downward during the increased action of force in each case by more than 0.5° and/or by more than 2 mm with respect to a predetermined starting position.

11. The seat as claimed in claim 7, wherein the respective lower belt anchorage point is pivotable and/or shiftable during the increased action of force in each case by more than 0.5° and/or by more than 2 mm with respect to a predetermined starting position.

12. The seat as claimed in claim 1, wherein the lower belt anchorage points are configured such that they are movable in an advancing manner forward and/or downward exclusively during the control-induced increased action of force.
